(19) United States
(12) Patent Application Publication
(10) Pub. No.: US 2007/0081649 A1
(43) Pub. Date: Apr. 12, 2007

(54) Method and system for selectively protecting shared contact information

(75) Inventors: Daniel A. Baudino, Lake Worth, FL (US); Carlos A. Rivera-Cintron, Lake Worth, FL (US); Michael T. Vincent, Lake Worth, FL (US); Jose E. Korneluk, Boynton Beach, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/235,762

(22) Filed: Sep. 27, 2005

(51) Int. Cl. H04M 3/42

(52) U.S. Cl. 379/201.11

(57) ABSTRACT

A method (10) of selectively protecting contact information can include sending (11) contact information from a calling party to a called party, selectively hiding (12) portions of the contact information from the called party, and enabling (14) the called party to contact the calling party. The method can further restrict (16) the called party from contacting the called party in a predetermined context such as in relation to time and/or location. The method can further optionally disable (18) the ability for the called party to edit the contact information or the ability for the called party to forward the contact information to a third party. The method can optionally enable (20) the called party to contact the calling party a predetermined number of times or enable to share (22) portions of the contact information with a predetermined group.

### FIELD OF THE INVENTION

This invention relates generally to controlling use of contact information, and more particularly to a method and system for selectively protecting contact information sent to third parties.

### BACKGROUND OF THE INVENTION

Today's electronic phonebooks fail to offer protection to a user to prevent sharing of phone numbers and other potentially sensitive information that can be sent over Push to Exchange or any other similar mechanisms. A commonly used format and standard interchange protocol is the vCard and vCard interchange protocol. A vCard is an electronic business (or personal) card and also the name of an industry specification for the kind of communication exchange that is done on business or personal cards. vCards are commonly found or attached to an e-mail note sent to a recipient. Because vCard is a published industry specification, software application developers can create programs that process vCards by letting a user view them, or drag-and-drop them to an address book or some other application. vCards can include images and sound as well as text.

The vCard specification makes use of the “person” object defined by the CCITT X.500 Series Recommendation for Directory Services and can be considered an extension of it. A vCard contains a name, address information, date and time, and optionally photographs, company logos, sound clips, and geo-positioning information. To view or open a vCard that someone has attached to an e-mail note, an e-mail program needs to support vCards.

Prior attempts to provide some protection can include the use of the blind carbon copy (BCC) function found in many email systems. This is a copy of an e-mail message sent to a recipient without the recipient's address appearing in the message and not the entire entry. The BCC does not allow the receiver to send an e-mail to other addresses on the BCC list. In other words, the sender can hide some information but there is no way for the sender to selectively enable the recipient user to see and still make limited use of some of the information to make a phone call or write an email to the third party. Digital Rights Management (DRM) focuses on security and encryption as a means of solving the issue of unauthorized copying for digital media. With DRM, the media protected cannot be shared, or used if not authorized.

### SUMMARY OF THE INVENTION

Embodiments in accordance with the present invention can enable a user to selectively protect portions of their contact information, particularly when sending it to a third party. One embodiment can utilize a vCard modified to have a privacy flag. Such embodiments can include methods to hide, auto delete (using an expiration timer or event timer or counter), or other limitations based on context using time or location for example.

In a first embodiment of the present invention, a method of selectively protecting contact information can include the steps of sending contact information from a calling party to a called party, selectively hiding portions of the contact information from the called party, and enabling the called party to contact the calling party. The method can further restrict the called party from contacting the called party in a predetermined context such as in relation to time and/or location. The method can further disable the ability for the called party to edit the contact information or the ability for the called party to forward the contact information to a third party. The method can enable the called party to contact the calling party a predetermined number of times or to share portions of the contact information with a predetermined group. The contact information can come in the form of a vCard, for example, and such vCard can be removed from the called party's access by sending a second vCard with a delete flag turned on in order to disable the vCard or by sending an SMS message or email containing instructions to perform a similar function. To provide further assurances of privacy the method can also automatically block Caller ID when sending contact information. Note, the contact information can contain any number of information fields that might be considered sensitive by a calling party including a mobile phone number, a work phone number, a home phone number, an IP address, an email address, an SMS address, a location identifier, or a facsimile number or other information that can be contained in a vCard or other type of contact information exchange format. In this regard, the calling party can hide any of the foregoing information fields from the called party. For further privacy, the method can also block location information (such as GPS information) from the calling party to the called party.

In a second embodiment of the present invention, a communication system can include a transceiver and a processor coupled to the transceiver. The processor can be programmed to send contact information from a calling party to a called party, selectively hide portions of the contact information from the called party, and enable the called party to contact the calling party. The system can be further programmed to restrict the called party from contacting the called party in a predetermined context or to disable the ability for the called party to edit the contact information or disable the ability for the called party to forward the contact information to a third party. The system can be further programmed to enable the called party to contact the calling party a predetermined number of times. Contact information can be sent in any number of formats including a vCard. The vCard can be disabled by sending a second vCard with a delete flag turned on or by sending instructions to disable the vCard using an SMS message or an email. The system can further be programmed to automatically block Caller ID or a location identifier when sending contact information.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart illustrating another method of selectively protecting contact information in accordance with an embodiment of the present invention.

FIG. 2 is a contact information edit screen used by a sender or a calling party in accordance with an embodiment of the present invention.

FIG. 3 is a system for selectively protecting contact information in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments in accordance with the invention enable a user to share numbers, addresses and other sensitive information on a selective basis via Push to Exchange (using Bluetooth, IRDA, PTT, PoC, or other means such as vCard) by activating a flag or flags so that a receiving party can add the sensitive information to the phone book but as a “call only” or with other restrictions that can be customized by the sender. That is, the receiving user can keep a phone number or other contact information on their phone book, but it can be hidden from him or her. In such a scenario, when the contact is highlighted, the user can press send only and view or edit will not respond or the view or edit options are disabled (grayed out). This phone book entry can be used to make a phone call, write an e-mail, or perform other contacting function, but the contact information can be concealed to anybody manually (preventing the user from writing the number down and pass it to somebody else) or digitally (preventing further push to exchange). Such scheme can protect the sender of contact information from further unauthorized distribution and provide a degree of privacy while still enabling the recipient to use the received information to accomplish an intended task or tasks.

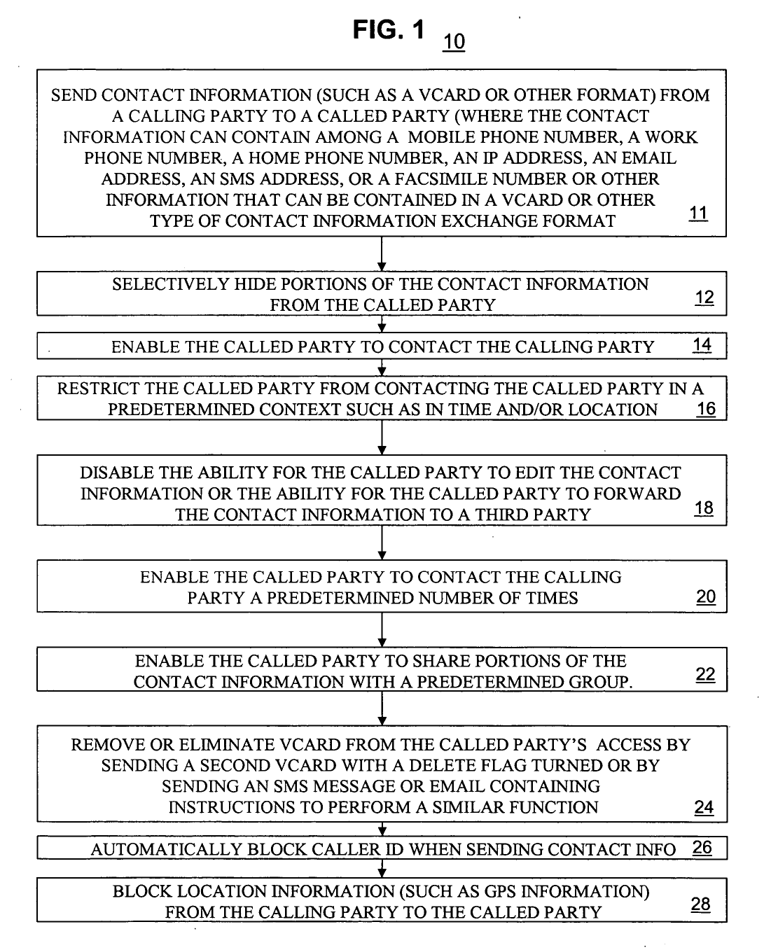

Referring to FIG. 1, a method 10 of selectively protecting contact information can include the step 11 of sending contact information from a calling party to a called party, selectively hiding portions of the contact information from the called party at step 12, and enabling the called party to contact the calling party at step 14. The method 10 can further restrict the called party from contacting the called party in a predetermined context such as in relation to time and/or location at step 16. The method 10 can further optionally disable the ability for the called party to edit the contact information or the ability for the called party to forward the contact information to a third party at step 18. The method 10 at step 20 can optionally enable the called party to contact the calling party a predetermined number of times or at step 22 to share portions of the contact information with a predetermined group. The contact information can come in the form of a vCard, for example, and such vCard can be removed from the called party's access by sending a second vCard with a delete flag turned on in order to disable the vCard or by sending an SMS message or email containing instructions to perform a similar function at step 24. To provide further assurances of privacy the method 10 at step 26 can also automatically block Caller ID when sending contact information. Note, the contact information can contain any number of information fields that might be considered sensitive by a calling party including a mobile phone number, a work phone number, a home phone number, an IP address, an email address, an SMS address, or a facsimile number or other information that can be contained in a vCard or other type of contact information exchange format. In this regard, the calling party can hide any of the foregoing information fields from the called party. For further privacy, the method 10 can also block location information (such as GPS information) from the calling party to the called party at step 28.

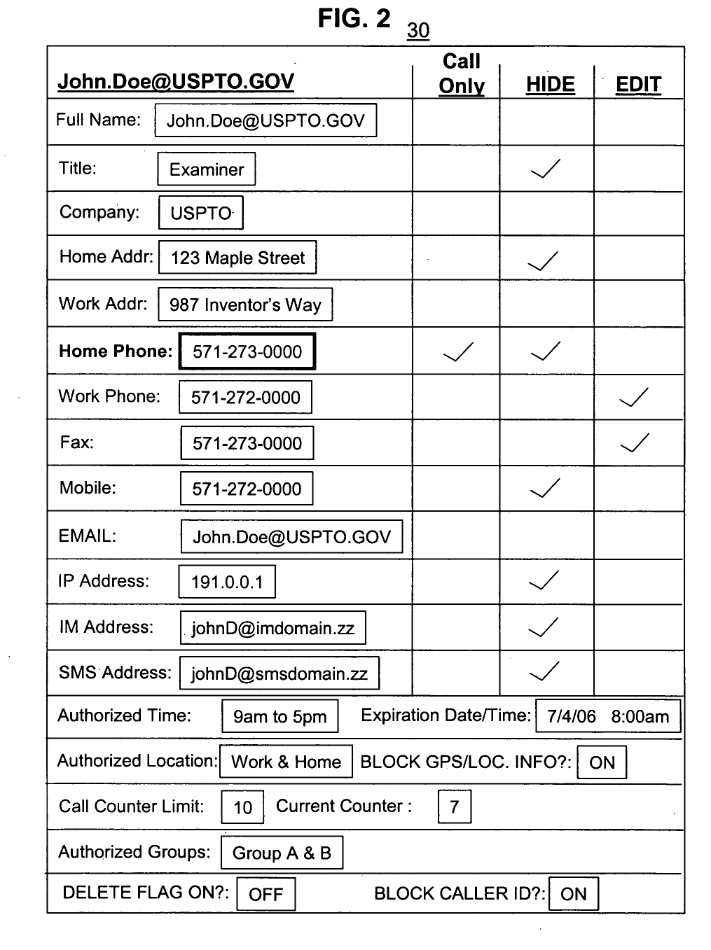

Referring to FIG. 2, a sample contact information edit screen or user interface 30 that can be used by a sender or a calling party is shown. Such edit screen can be made to conform to the vCard standards. This example includes a number of fields such as full name, title, company, home address, work address, home phone, work phone, fax number, mobile number, email address, internet protocol (IP) address, instant messaging (IM) address, and short messaging service (SMS) address. Each field can include a pull-down menu of other appropriate fields as necessary such as alternate fax numbers or phone numbers. The user interface 30 can further include flags or check-boxes that can enable hiding or editing of any of the aforementioned fields. Another column of check-boxes or flags can enable a call only function even though such information might be hidden to a recipient of such information. For example, even though a sender's home phone is flagged as hidden, the recipient will still be able to call the sender at the home phone by selecting the sender's name and the send button without ever actually seeing the actual phone number.

Other enhancements can limit calls to a particular context. In this regard, context can mean a certain time or location or both. Although there are numerous fields to select from, one particular field can be selected such as the highlighted Home Phone and then a particular context for the highlighted field can be defined. In this example, the sender is allowing the recipient to call at work or at home between the hours of 9 am and 5 pm until Jul. 4, 2006 at 8 am. The sender is also limiting the recipient to a predetermined number of calls to this contact (in this instance 10 calls of which 7 have already been made). The call limit feature can be useful for customer service applications that need to be limited in scope.

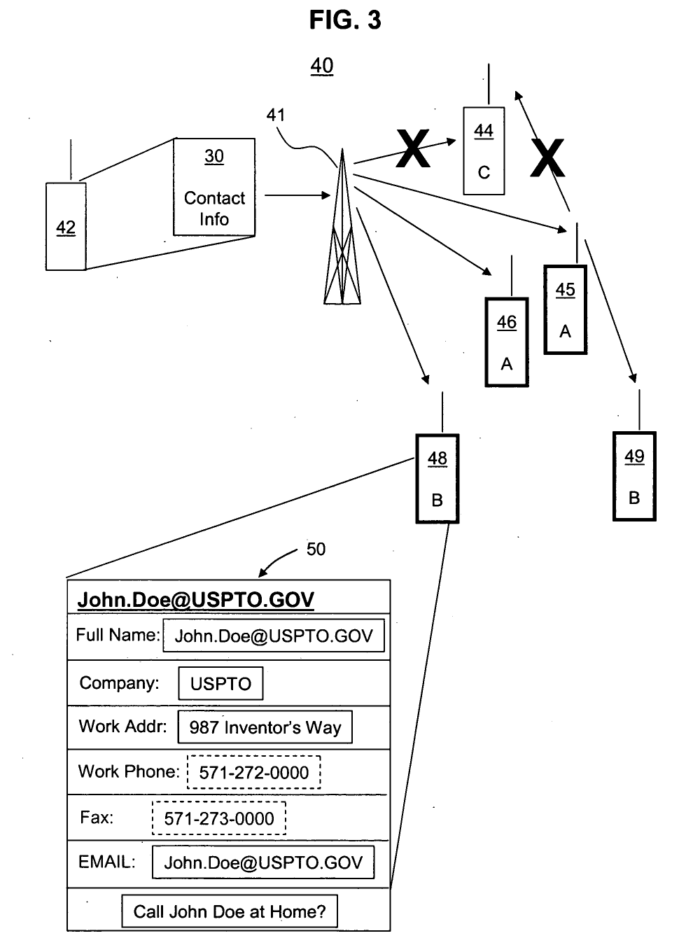

In FIG. 3, in a corresponding system 40 for selectively protecting contact information, an electronic product such as a mobile radio 42 or cell phone having the contact information from the user interface 30 (of FIG. 2) can transmit such information (as customized and limited by the user of mobile radio 42) to other designated recipients such as mobile radios 45, 46, and 48 via a communication network 41. Corresponding to the settings shown in the user interface or screen 30 of FIG. 2, a contact information screen 50 at the recipient 48 can include the basic information as customized or selected by the sender such as full name, company, work address, work phone, fax, and an email. Note, the home number and mobile numbers are hidden from the user, but the contact information allows the recipient to call John Doe at home using a special button on the bottom. Also note that the work phone and fax numbers can be edited as authorized or permitted by the sender of the contact information.

In another particular embodiment using a vCard, the sender can also add an expiration timer flag on the vCard shared. This way, the vCard shared will expire and will be automatically deleted from the recipient's phone book after the predetermined time. This will be useful in the event one can send a message or email, but knows it will be of no use or value after a certain time. An alternative to the timer is a number of times the phone number can be used as explained above. The setting can be “one time only” where the receiver of the shared vCard can use it only once.

The receiver of the vCard can share the vCard with another user as long as the sender has authorized the receiver to do so. This can be implemented in a number of ways including the use of designating authorized groups. In this instance, members of Group A and B can receive and share certain contact information, but they cannot pass such information to non-members. (See FIG. 3, where radios 45, 46, and 48 can receive the contact information 30 and can share with radio 49 since they are all members of Group A or B. Radio 44, being a non-member of Group A or B (and more particularly a member of Group C) cannot receive contact information from the sender (as set by the sender's customized settings) nor have such information forwarded by any of the Authorized Groups. Again, when appropriately set, the new receiver can see the name and use it but cannot see the content of the newly received information.

This privacy feature is very useful when somebody wants to share their cell phone or home phone number, but does not want to be bothered again on his or her private number. The phone number is used temporarily and then goes away from the phone book and the sender's phone number is protected.

In another scenario where people (such as coworkers and vendors) might only desire to temporarily share contact information can occur while on a particular project. Every time a new project is started, all the people involved share their numbers. After the project is finished, those numbers stay on the recipient's phone book and new numbers are added whether sender intended such unlimited sharing of contact information or not. A timer can be set for the duration of the project, so that after the project is terminated the entire contact information exchanged (or a portion thereof) in relation to the project can be deleted and free-up more memory on the phone.

An alternative to the expiration timer is a flag that the user can send with the vCard file or an update to the vCard file, so when he or she decides the entry can be erased at his or her will. The dynamic erasure can be done by sending a second vCard file with a delete flag turned on. When the receiver receives the vCard with the flag turned on, it can automatically remove the entry from the local phone book. This is useful when the duration of the project is unknown. Everybody on the project can share their phone numbers and other contact information and activate the delete flag when desired. After the project is finished, each individual user can send the vCard flag with the “delete” flag on, so their number or other contact information will be removed from the receiver's phone book. As noted above, the sender can request the elimination of the vCard using many alternatives, such as sending an SMS message, sending another vCard with the delete flag activated (the receiving device deletes all matching vCards), or sending an e-mail requesting the system to erase the vCard. In one embodiment, the vCard can only be eliminated if the user who originally sent the vCard had the option to delete (using flags) turned on.

In another embodiment, the same concept can be applied to shared phone books. For example, corporate directories can have all the names and numbers posted on the directory with the “use only” flag turned on for the desired contacts and more sensitive information hidden as desired. When an authorized user (for example, employees authorized to have access to the CEO mobile phone) retrieves the contact name, the security is inherited and transferred to the phone so the receiving user cannot transfer the number to another phone book.

Other features in accordance with the embodiments herein can include automatically blocking Caller ID features when sending the vCards or contact information, otherwise the protection of certain contact information can be defeated. Blocking Caller ID can prevent a caller's phone number from appearing on a called party's display or from being captured in a recent call list. The contact information or vCARD format can be made to be flexible enough to allow some numbers to be visible, some invisible, and some call only. For example, if the sender wants to send a vCARD with only the sender's mobile number, the user interface can do so and still block the sender's fax and home numbers if desired. Another precaution can include blocking of indications that some phones and phone systems include to differentiate local from long distance calls since these features can also give an indication of the location of a user. More importantly, such a system can exclude (block, or make invisible) all location information (GPS location information, etc.) from the caller to further protect a caller's privacy. As noted above, numbers can optionally be blocked based on location and time information. For example, a vCARD can be set so that a recipient can only call the sender only during working hours (9 am-5 pm) if the caller (recipient) is located in the general vicinity (1 km radius from where original sender and caller are located). There are many other combinations and restrictions or limitations that can be done based on this information or other contextual information. Restrictions or context-based blocking can be based on location, time, date (e.g., weekday, weekend), or environment (e.g., in the car, busy, at home, in the office, etc.) Further note that these concepts are not limited to phone numbers, but can certainly be applied to IP addresses (as in the case of WLAN and VolP phones) where a recipient can not necessarily see another user's IP address is such a setting is desired.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of selectively protecting contact information, comprising the steps of:
sending contact information from a calling party to a called party;
selectively hiding portions of the contact information from the called party; and
enabling the called party to contact the calling party.

2. The method of claim 1, wherein the method further comprises the step of restricting the called party from contacting the called party in a predetermined context.

3. The method of claim 1, wherein the method further comprises the step of disabling the ability for the called party to edit the contact information.

4. The method of claim 1, wherein the method further comprises the step of disabling the ability for the called party to forward the contact information to a third party.

5. The method of claim 1, wherein the method further comprises the step of enabling the called party to contact the calling party a predetermined number of times.

6. The method of claim 1, wherein the method further comprises the step of enabling the sharing of portions of the contact information with a predetermined group.

7. The method of claim 1, wherein the step of sending contact information comprises sending a vCard, and the method further comprises the step of sending a second vCard with a delete flag turned on in order to disable the vCard.

8. The method of claim 1, wherein the step of sending contact information comprises sending a vCard, and the method further comprises the step of eliminating the vCard by sending an SMS message or an email.

9. The method of claim 1, wherein the method further comprises the step of automatically blocking Caller ID when sending contact information.

10. The method of claim 1, wherein the step of sending contact information comprises sending vCard information or IP addresses, or email addresses or location information.

11. The method of claim 1, wherein the step of selectively hiding portions comprises hiding one more among a mobile phone number, a work phone number, a home phone number, an IP address, an email address, an SMS address, or location identifier, or a facsimile number from the called party.

12. The method of claim 1, wherein the method further comprises the step of blocking location information from the calling party to the called party.

13. A communication system, comprising:
a transceiver; and
a processor coupled to the transceiver, wherein the processor is programmed to:
send contact information from a calling party to a called party;
selectively hide portions of the contact information from the called party; and
enable the called party to contact the calling party.

14. The communication system of claim 13, wherein the system is further programmed to restrict the called party from contacting the called party in a predetermined context.

15. The communication system of claim 13, wherein the system is further programmed to disable the ability for the called party to edit the contact information or disable the ability for the called party to forward the contact information to a third party.

16. The communication system of claim 13, wherein the system is further programmed to enable the called party to contact the calling party a predetermined number of times.

17. The communication system of claim 13, wherein the system is further programmed to send contact information by sending a vCard and further disable the vCard by sending a second vCard with a delete flag turned.

18. The communication system of claim 13, wherein the system is further programmed to automatically block Caller ID or a location identifier when sending contact information.

19. A machine-readable storage, having stored thereon a computer program having a plurality of code sections executable by a machine for causing the machine to perform the steps of:
sending contact information from a calling party to a called party;
selectively hiding portions of the contact information from the called party; and
enabling the called party to contact the calling party.

20. The machine-readable storage of claim 19, wherein the machine-readable storage is further programmed to restrict the called party from contacting the called party in a predetermined context in terms of time or location.
